(19) United States
(12) Patent Application Publication
(10) Pub. No.: US 2011/0113995 A1
(43) Pub. Date: May 19, 2011

(54) METHOD AND APPARATUS FOR PLANTING AND IRRIGATION

(75) Inventor: Jochen Pfrenger, Omaha, NE (US)

(73) Assignee: LINDSAY CORPORATION, Omaha, NE (US)

(21) Appl. No.: 12/944,072

(22) Filed: Nov. 11, 2010

Related U.S. Application Data
(60) Provisional application No. 61/260,987, filed on Nov. 13, 2009.

(51) Int. Cl. A01C 7/00; A01G 29/00

(52) U.S. Cl. 111/127

(57) ABSTRACT

A planting and irrigation apparatus and method for planting seeds in and irrigating a field. The apparatus may comprise a plurality of spray nozzles configured with a pressure setting sufficient for forming a plurality of holes into soil of the field and a seed dispenser configured for dispensing one or more seeds into one or more of the holes. Once the seeds are dispensed throughout the field, the apparatus may irrigate the field, thereby washing soil displaced when the holes were formed back into the holes, thereby covering the seeds.

### RELATED APPLICATIONS

This non-provisional patent application claims priority benefit with regard to all common subject matter of the earlier filed U.S. Provisional Patent Application titled “Water Jet Seeding”, Ser. No. 61/260,987, filed on Nov. 13, 2009, which is hereby incorporated by reference in its entirety into the present application.

### BACKGROUND

Embodiments of the present invention relate to an apparatus and method for planting and irrigating rice.

### RELATED ART

The traditional method for cultivating rice is to flood the field or paddy in which it is planted. While this works well for low-lying areas near rivers and other water sources, it is not practical for higher elevation fields and/or fields with no such water sources nearby.

Rice that is not flood cultivated can also be irrigated with mechanized irrigation equipment, but the rice seeds must first be drilled into the ground. Prior art mechanized irrigation equipment cannot perform this function, so a separate process for seeding rice is required that does not utilize the irrigation system. Thus, the planting and irrigating of rice fields is more time consuming and more costly than desired, since multiple pieces of equipment must be used.

Accordingly, there is a need for an irrigating apparatus that overcomes the limitations of the prior art.

### SUMMARY

Embodiments of the present invention solve the above-mentioned problems and provide a distinct advance in the art of planting and irrigating rice. Various embodiments of the invention include a planting and irrigating apparatus comprising a plurality of spray nozzles having one or more pressure settings and a seed dispenser.

A method of planting seeds in and irrigating a field according to an embodiment of the present invention may comprise spraying a field with spray nozzles at a pressure setting sufficient to form a plurality of holes in the soil of the field; dispensing seeds throughout the field with a seed dispenser; and heavily irrigating the field, thereby washing soil displaced when the holes were formed back into the holes to simultaneously cover and irrigate the seeds.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the preferred embodiments and the accompanying drawing figures.

### BRIEF DESCRIPTION OF THE DRAWING FIGURES

Embodiments of the present invention are described in detail below with reference to the attached drawing figures, wherein:

FIG. 1 is a block diagram of a planting and irrigating apparatus constructed in accordance with an embodiment of the invention;

FIG. 2 is a fragmentary schematic drawing of a spray nozzle of the apparatus of FIG. 1 shown shooting water into soil in a field;

FIG. 3 is a fragmentary schematic drawing of the spray nozzle of FIG. 2 shown forming a seed hole as a result of shooting water into the soil;

FIG. 4 is a fragmentary schematic drawing of the spray nozzle of FIG. 2 shown turned off after forming the seed hole;

FIG. 5 is a fragmentary schematic drawing of the field and the seed hole of FIG. 4 after seeds have been dispensed into the field;

FIG. 6 is a fragmentary schematic drawing of the spray nozzle of FIG. 2 shown irrigating the field;

FIG. 7 is a fragmentary schematic drawing of the spray nozzle of FIG. 6 shown irrigating the field and further showing liquid from the spray nozzle moving loose soil into the seed hole;

FIG. 8 is a fragmentary schematic drawing of the field of FIG. 7 after the seeds are buried with loose soil via irrigation; and

FIG. 9 is a flow chart of a method of planting and irrigating a field in accordance with an embodiment of the invention.

The drawing figures do not limit the present invention to the specific embodiment disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

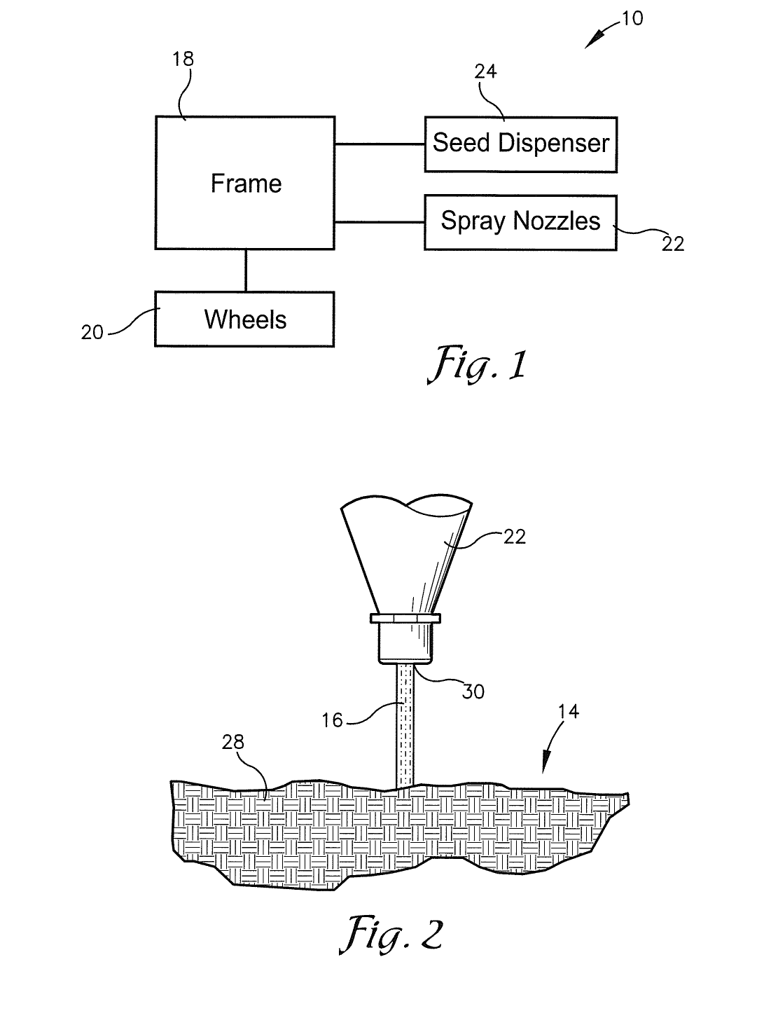

Embodiments of the present invention, as illustrated in FIGS. 1-9, include a planting and irrigating apparatus 10 configured for planting seeds 12 in and irrigating a field 14 with a fluid 16, such as water. The seeds 12 may be any variety of seeds, grain, etc., such as rice. The apparatus 10, as illustrated in FIG. 1, may comprise a frame 18, one or more wheels 20, and one or more spray nozzles 22 connected to a supply of liquid (not shown), such as a water supply. The apparatus 10 may be manually pushed or pulled across the field 14 or actuated via a motor and/or a control system, such as those known in the art for various agricultural implements. The apparatus 10 may also comprise one or more seed dispensers 24, such as air seeders, configured for dispensing the seeds 12 into the field 14.

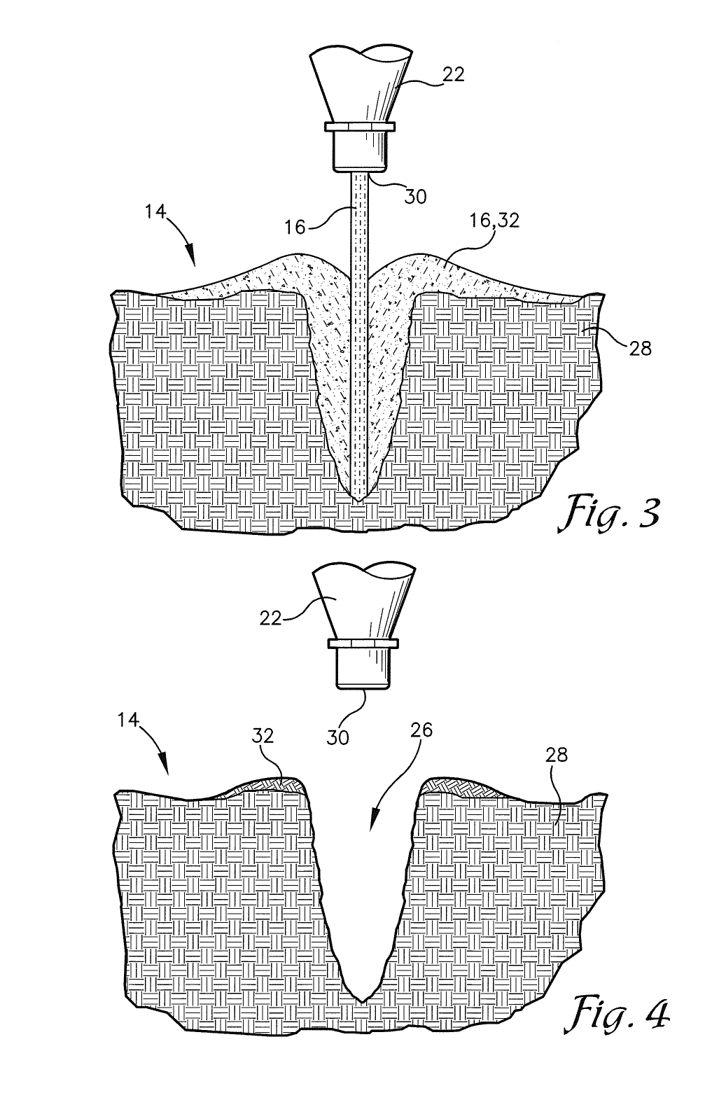

The spray nozzles 22 may be configured to create holes 26, as illustrated in FIGS. 4-5, for the seeds 12 to be dispensed into. In some embodiments of the invention, the spray nozzles 22 may be additionally or alternatively configured to create trenches or furrows for the seeds 12 to be dispensed into. Furthermore, in some embodiments of the invention, the same spray nozzles 22 may additionally or alternatively be configured to irrigate the field 14. The spray nozzles 22 may be arranged on the apparatus 10 to point downward toward soil 28 in the field 14.

The spray nozzles 22 may also have one or more pressure settings. At least one of the pressure settings may be sufficient to form the holes 26 or trenches of a predetermined depth as required for a predetermined type of seed 12. For example, pressure, flow, and/or duration of the spray nozzles 22 being open may be varied to achieve a desired ground penetration for a desired depth of the holes 26 or trenches based on soil conditions. The spray nozzles 22 may have one or more openings 30, as referenced in FIGS. 2-4, sized and configured to create the holes 26 or trenches of a predetermined width or diameter. To create trenches, the spray nozzles 22 may be set to an open position continuously as the apparatus 10 is moved across the field 14. To create the holes 26, the spray nozzles 26 may pulsate or alternate between open and closed as the apparatus is moved across the field.

At least one of the pressure settings of the spray nozzles 22 may also be sufficiently low to not create the holes 26 or trenches. This lower pressure setting may be used for irrigating the field 14 after the seeds 12 have been dispensed in the holes 26 or trenches. In an alternative embodiment of the invention, the planting and irrigating apparatus may comprise a second set of hoses and/or nozzles (not shown) separate from the spray nozzles 22 noted above. This second set of hoses and/or nozzles may be used for irrigating the field, while the spray nozzles 22 may be used for creating the holes 26 or trenches for the seeds.

The seed dispensers 24 may be any type of seed dispensing device, such as an air seeding device. Some embodiments of the seed dispensers 24 may include a seed hopper, a seed wheel, a metering unit for counting seeds and/or isolating individual seeds to be dispensed one at a time, and other seed dispensing mechanisms known in the art. For example, the seed dispenser 24 may drop a preset number of seeds at preset distance intervals. However, in an alternative embodiment of the invention, the seeds 12 may be dispensed in the field by hand or by a seed dispenser not attached to the apparatus 10.

A method of using the planting and irrigating apparatus 10 to plant seeds 12 and irrigate the field 14 may comprise forming holes 26 or trenches by spraying liquid 16 into the soil 28 with the spray nozzles 22; dispensing the seeds 12 into the holes 26 or trenches by the seed dispenser 24, by hand, or by any other seed dispensing apparatus; and then irrigating the field 14.

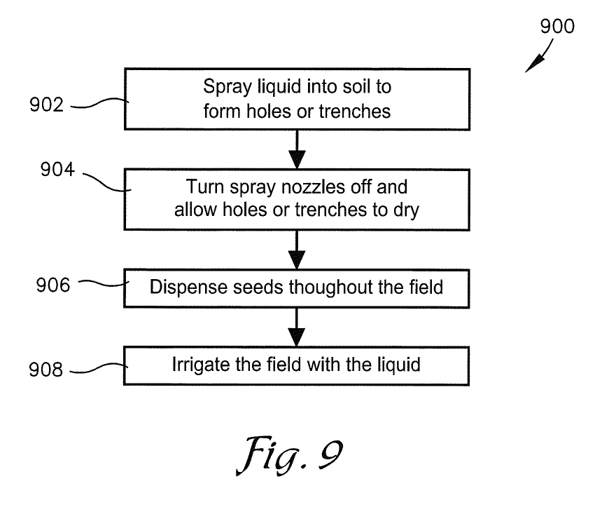

The flow chart of FIG. 9 depicts the steps of an exemplary method 900 of the invention in more detail. In some alternative implementations, the functions noted in the various blocks may occur out of the order depicted in FIG. 9. For example, two blocks shown in succession in FIG. 9 may in fact be executed substantially concurrently, or the blocks may sometimes be executed in the reverse order depending upon the functionality involved.

The method 900, as illustrated in FIG. 9, may comprise forming one or more of the holes 26 or trenches by spraying liquid 16 into the soil 28 in the field 14, as depicted in step 902 and illustrated in FIGS. 2-3. For example, the spray nozzles 22 may be set at a first pressure setting and sprayed continuously across the length of the field 14 one or more times to create at least one trench. Alternatively, the spray nozzles 22 may be set at the first pressure setting and pulsated to turn off and on at a particular time interval or distance interval as the apparatus 10 is moved across the length of the field 14, thereby creating at least one row of the holes 26 in the field 14.

A portion of the soil 28 loosened and displaced when holes 26 or trenches are formed, referred to herein as loose soil 32, may naturally rest outward of the holes 26 or trenches around the periphery thereof, as illustrated in FIG. 4. For example, when forming the holes 26 or trenches, the spray nozzles 22 may spray a sufficient quantity of liquid 16 at a sufficient pressure such that the liquid 16 pushes this loose soil 32 outward of the holes 26 or trenches. The trenches may be substantially v-shaped and/or the holes 26 may be substantially conical in shape. However, the spray nozzles 22 may be configured to form holes 26 or trenches of any configuration.

In some embodiments of the invention, as depicted in step 904 and illustrated in FIG. 4, the spray nozzles 22 may be turned off and the holes 26 or trenches may be allowed to dry. Then, as depicted in step 906 and illustrated in FIG. 5, one or more of the seeds 12 may be dropped into the field 14. For example, a predetermined number of seeds 12 may be dropped into each of the holes 26. Alternatively, a predetermined number of seeds 12 may be dropped at preset distance intervals in the trenches. However, depending on the precision of the seed dispenser 24, the seeds 12 may or may not be dropped precisely into the holes 12 or trenches, particularly in embodiments of the invention in which the seeds 12 are dispensed manually or by hand. However, at least some of the seeds 12 that do not land in the holes 26 or trenches may wash into the holes 26 or trenches during irrigation of the field 14, as later described herein.

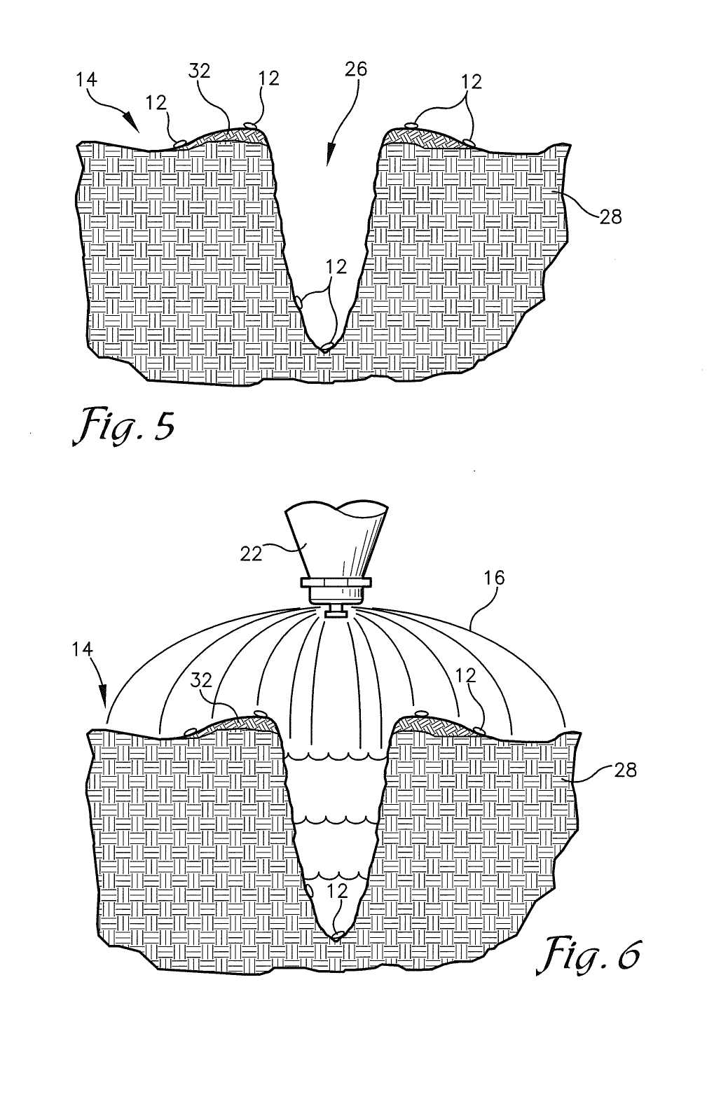

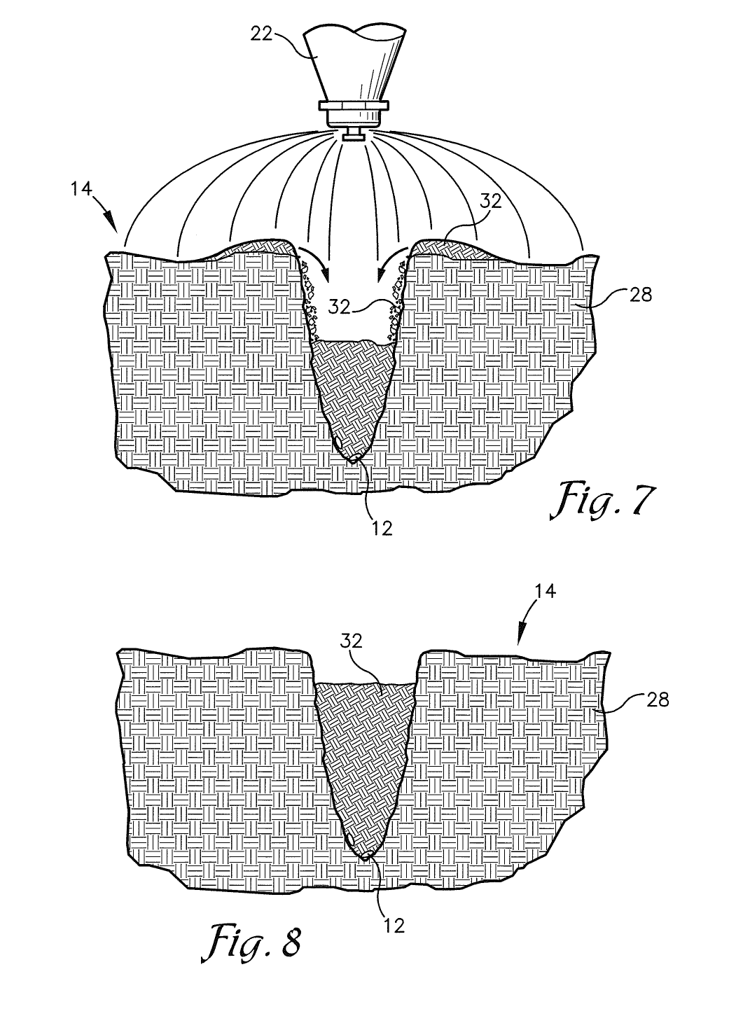

As depicted in step 908 and illustrated in FIGS. 6-7, the field 14 may then be irrigated with a liquid 16, such as water. In some embodiments of the invention, the spray nozzles 22 may dispense a desired amount of the liquid 22 into the field 14 at a second pressure setting, thereby heavily irrigating the field 14. In other embodiments of the invention, a separate second set of nozzles (not shown) may dispense the liquid 16 at a second pressure setting to irrigate the field 14. However, the field 14 may be irrigated using any apparatus or method known in the art. The holes 26, trenches, and/or the soil 28 surrounding the holes or trenches may be irrigated heavily enough that the seeds 12 may float upward within the holes 26 or trenches. Then, as the irrigating apparatus 10 moves forward, the liquid 16 may percolate into the ground and the seeds 12 may float into the holes 26 or trenches where they float to the bottom of the holes 26 or trenches along with the receding liquid 16 therein.

As illustrated in FIG. 7, the liquid 16 or water sprayed into the soil 28 immediately surrounding the holes 26 or trenches may flow toward the holes 26 or trenches. The loose soil 32 displaced when the holes 26 or trenches were formed may thereby be washed toward or drain into the holes 26 or trenches. For example, the spray nozzles 22 may spray a sufficient quantity of liquid 16 over a sufficient area at the holes 26 or trenches and around the holes 26 or trenches to sweep the loose soil 32 back into the hole or trench, covering one or more of the seeds therein. Additionally, some seeds 12 located slightly outward of the holes 26 or trenches may be washed into the holes 26 or trenches during irrigation. In some embodiments of the invention, subsequent irrigation cycles are required to fill the holes 26 or trenches with the loose soil 32, thereby covering the seeds 12.

Finally, the spray nozzles 22 may be turned off and/or the apparatus 10 may be removed from the field 14. At this point, the seeds 12 rest within the holes 26 or trenches, covered by the loose soil 32, as illustrated in FIG. 8.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A method for planting and irrigating seeds in a field, the method comprising:
forming a hole or trench into soil of the field by spraying liquid from a spray nozzle of an irrigation apparatus at the soil;
dispensing one or more seeds into the hole or trench; and
irrigating the field, including the hole or trench, with the irrigation apparatus.

2. The method of claim 1, wherein dispensing the one or more seeds in the hole or trench is performed by an air seeder.

3. The method of claim 1, wherein the method further comprises forming a plurality of holes or trenches throughout the field with the spray nozzle or a plurality of spray nozzles of the irrigation apparatus.

4. The method of claim 1, wherein the spray nozzle that forms the hole or trench also dispenses the liquid to irrigate the field.

5. The method of claim 5, wherein the spray nozzle has a plurality of settings, and a different pressure setting is used to form the hole or trench than to irrigate the field.

6. The method of claim 1, wherein forming the hole or trench further comprises pulsating the spray nozzle as the irrigation apparatus is moved across the field, thereby forming a plurality of holes.

7. The method of claim 1, wherein when forming the hole or trench, the spray nozzle sprays a sufficient quantity of liquid at a sufficient pressure such that the liquid pushes a portion of soil outward of the hole or trench.

8. The method of claim 7, wherein irrigating the field comprises spraying a sufficient quantity of liquid over a sufficient area at the hole or trench and around the hole or trench to sweep the portion of the soil pushed outward of the hole or trench during formation thereof back into the hole or trench, covering one or more of the seeds therein.

9. A method for planting and irrigating rice in a field, the method comprising:
forming a plurality of holes into soil of the field by spraying liquid from a spray nozzle of an irrigation apparatus into the soil at predetermined intervals as the spray nozzle is moved across the field;
dispensing one or more seeds into one or more of the holes; and
irrigating the field, including the holes, with the irrigation apparatus.

10. The method of claim 9, wherein the spray nozzle that forms the holes also dispenses the liquid to irrigate the field.

11. The method of claim 10, wherein the spray nozzle has a plurality of settings, and a different pressure setting is used to form the holes than to irrigate the field.

12. The method of claim 9, wherein the holes formed by the spray nozzle have a cone-like shape, and the spray nozzle sprays a sufficient quantity at a sufficient pressure to push or displace a portion of soil outward of the holes.

13. The method of claim 12, wherein irrigating the field comprises spraying a sufficient quantity of liquid over a sufficient area at the holes and around the holes to sweep the portion of the soil pushed outward of the holes during formation thereof back into the holes, covering one or more of the seeds therein.

14. A planting and irrigating apparatus configured for planting and irrigating seeds in a field, the apparatus comprising:
a first plurality of spray nozzles configured for spraying water into the field at a first pressure sufficient to create one or more holes or trenches; and
an air seeder apparatus configured for dropping one or more seeds into the one or more holes or trenches.

15. The apparatus of claim 14, wherein the first plurality of spray nozzles are also configured to irrigate the field at a second pressure that is lower than the first pressure used to create the one or more holes or trenches.

16. The apparatus of claim 15, further comprising a frame to which the first plurality of spray nozzles and the air seeder apparatus are attached and one or more wheels configured to move the planting and irrigating apparatus across the field.

17. The apparatus of claim 16, wherein the first plurality of spray nozzles are configured to spray at the first pressure continuously as the planting and irrigating apparatus is moved across the field to form the one or more trenches.

18. The apparatus of claim 16, wherein the first plurality of spray nozzles are configured to pulsate at the first pressure, opening and closing as the planting and irrigating apparatus is moved across the field, thus forming the one or more holes.

19. The apparatus of claim 14, wherein the first pressure is sufficient to displace a portion of soil outward of the holes or trenches.

20. The apparatus of claim 14, further comprising a second plurality of spray nozzles configured for irrigating the field with a sufficient quantity of liquid over a sufficient area at and around the holes or trenches to sweep a portion of soil pushed outward of the holes or trenches during formation thereof back into the holes or trenches, covering one or more of the seeds therein.
